(19) United States
(12) Patent Application Publication
(10) Pub. No.: US 2015/0371725 A1
(43) Pub. Date: Dec. 24, 2015

(54) INORGANIC MATERIAL PASTE FOR ELECTRONIC COMPONENTS SUCH AS RESISTORS AND DIELECTRICS, AND METHOD OF PRODUCING SAME

(71) Applicant: NATIONAL INSTITUTE OF ADVANCED INDUSTRIAL SCIENCE AND TECHNOLOGY, Chiyoda-ku, Tokyo (JP)

(72) Inventors: Tetsuo Tsuchiya, Ibaraki (JP); Kentaro Shinoda, Ibaraki (JP); Tomohiko Nakajima, Ibaraki (JP)

(21) Appl. No.: 14/765,015

(22) PCT Filed: Jan. 29, 2014
(86) PCT No.: PCT/JP2014/051899

§ 371 Date: Jul. 31, 2015

(30) Foreign Application Priority Data
Feb. 4, 2013 (JP) 2013-019285

(51) Int. Cl. H01B 1/02

(52) U.S. Cl. CPC H01B 1/02

(57) ABSTRACT

An inorganic material paste obtained by mixing an organometallic compound, inorganic material particles, and a solvent. Additionally provided is an inorganic material paste obtained by mixing inorganic material particles, which are obtained by subjecting an organometallic compound to calcination or light irradiation, and a solvent. The foregoing inorganic material paste can reduce the amount of glass material, reduce the film thickness because the volume density of the functional material is high, yield favorable production efficiency, and achieve cost reduction since it is suitable for mass production. For instance, upon producing a thin film resistor, the resistor obtained by using the paste of the present invention is characterized in having superior stability even in the form of a thin film, and having minimal change in the resistance value caused by self-heating even under a high current. Consequently, this paste is useful in producing thick films of various oxide materials such as fluorescent substances, dielectrics and battery materials, without limitation to resistors.

### BACKGROUND

### Technical Field

The present invention relates to an inorganic material paste for producing electronic components such as resistors and dielectrics, and a method for producing the foregoing inorganic material paste.

Electronic components such as resistors and dielectrics are conventionally manufactured by screen-printing an inorganic material paste, which functions as a conductor or an insulator, on a substrate, and thereafter subjecting the substrate to drying and calcination.

As the conductive material of resistors, used are a material obtained by mixing a noble metal such as gold or silver or ruthenium oxide as the main component, glass frits (vehicle) for dispersing the main component, and a suitable amount of organic solvent.

Moreover, in recent years, as a resistor paste and its production method capable of forming resistors having high sensitivity and with minimal change in the resistance value caused by the creep phenomenon, reported is a method of using a resistor paste including glass frits, and conductive particles dispersed in the glass frits, wherein a glass composition having a higher softening point than the glass frits is used as the conductive particles (refer to Patent Document 1).

Moreover, as a method of forming, on a low-thermal expansion ceramic substrate, a lead-free thick film resistor with a stable resistance value that is not affected easily by fluctuations in the course of calcination, reported is a method of using ruthenium oxide as the conductive particles, and using a material having SiO₂—B₂O₃—K₂O glass as the main component and ruthenium oxide with K₂O₃ appended to the surface thereof and having a specific surface area of 30 to 80 m²/g as the glass frits (refer to Patent Document 2).

Furthermore, disclosed is a method of using a ruthenium oxide powder as the conductive particles, and adding glass frits thereto at a predetermined blending ratio and changing the composition of the glass frits to obtain a resistive paste for producing a resistor capable of improving the power durability and enabling high-speed printing.

Specifically, disclosed is a method of using a glass powder having a composition of PbO: 15 to 25 wt %, B₂O₃: 0.1 to 5.0 wt %, SiO₂: 15 to 25 wt %, Al₂O₃: 45 to 55 wt %, CaO: 0.1 to 5.0 wt %, and MgO: 0.1 to 5.0 wt %, or a glass powder having a composition of B₂O₃: 1 to 10 wt %, SiO₂: 60 to 70 wt %, Al₂O₃: 10 to 20 wt %, CaO: 10 to 20 wt %, MgO: 1 to 5 wt %, and Sb₂O₃: 0.1 to 2.0 wt %, and using conductive particles in an amount of 5 to 50 wt % and using glass frits in an amount of 50 to 95 wt % (refer to Patent Document 3).

Meanwhile, in recent years, pursuant to the development of power electronics such as SiC, thermal resistance under temperatures that are higher than the conventional operating temperature of 155° C. of electronic component materials is becoming required. In particular, since resistors are subjected to a temperature increase through self-heating caused by the current load in addition to the ambient temperature, resistors are subjected to temperatures that are higher than the used ambient temperature.

Since many materials are subjected to oxidation reaction or reaction with electrode materials as the temperature becomes higher, an important task in improving the thermal resistance is to suppress self-heating. Conventionally, while ruthenium oxide are used as the resistor material, rare metals such as ruthenium are facing the issue of resource depletion, and the development of alternative materials is also a matter of urgent need.

### PRIOR ART DOCUMENTS

### Patent Documents

[Patent Document 1] Japanese Patent Application Publication No. 2009-105263
[Patent Document 2] Japanese Patent Application Publication No. 2001-196201
[Patent Document 3] Japanese Patent Application Publication No. 10-335110

### SUMMARY OF THE INVENTION

### Problems to be Solved by the Invention

Conventionally, an inorganic material paste are a material including an inorganic material, glass, and a binder, and, for instance, resistors are produced by applying a paste containing ruthenium oxide on a substrate via screen printing or other methods, and then subjecting the substrate to calcination. The paste uses a ruthenium material, which is a rare metal, as its main component, and additionally uses a glass component and an organic vehicle, and thus it is difficult to reduce the film thickness in order to obtain the intended resistance value. Moreover, since the paste contains glass having low thermal conductivity, the heat radiation from the self-heating during the current load becomes insufficient, and heat radiation is enabled by reducing the amount of glass material or using a material with high thermal conductivity. The present invention was devised in view of the background, and an object of the invention is to provide an inorganic paste material that does not use glass, and, for example, to provide a paste for producing resistors without using a rare metal, which is capable of forming resistors with minimal change in the resistance value even under high temperatures.

### Means for Solving the Problems

Based on the above, the present invention provides the following invention:

1) An inorganic material paste obtained by mixing an organometallic compound, inorganic material particles, and a solvent.

2) The inorganic material paste according to 1) above, wherein the inorganic material paste is obtained by mixing inorganic material particles, which are obtained by subjecting an organometallic compound to calcination or light irradiation, and a solvent.

3) The inorganic material paste according to 1) or 2) above, wherein the organometallic compound is acetylacetonato or metal organic acid salt.

4) The inorganic material paste according to any one of 1) to 3) above, wherein the inorganic material particles are made from a metal oxide, metal material, or both.

5) The inorganic material paste according to any one of 1) to 4) above, wherein the inorganic material particles have a composition where A (at least one metal among Sb, Ta, Nb, Ga, Cu, Ba, and Sr) is contained in SnO₂ or RuO₂, and A/[A+(Sn or Ru)] is 2 to 25%.

6) The inorganic material paste according to any one of 1) to 4) above, wherein the inorganic material particles have a composition where A (at least one metal among Sb, Ta, Nb, Ga, Cu, Ba, and Sr) is contained in RuO₂ and SnO₂, and A/(A+Sn+Ru) is 2 to 25%.

7) The inorganic material paste according to any one of 1) to 6) above, wherein a component ratio (weight ratio) of inorganic material particles and the organometallic compound is 90/10 to 80/20.

8) The inorganic material paste according to any one of 1) to 7) above, wherein the inorganic material particles are (1+a)A₁₋ₓBₓMn_{1-y}Cu_{y}O₃ (−0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0).

9) The inorganic material paste according to any one of 1) to 7) above, wherein the inorganic material particles are Bi₂Sr₂(CaₓA₁₋ₓ)Cu₂O₈, component A is one or more types of metals selected from Y, La, Pr, Sm, Nd, Ho, Yb, Lu, Eu, Ce, Tm, and Er, and 0≦x≦1.0.

10) The inorganic material paste according to any one of 1) to 7) above, wherein the inorganic material particles are (1+a)A₁₋ₓBₓNiO₃ (−0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0).

11) A method of producing an inorganic material paste which is produced by adding a solvent to an organometallic compound and inorganic material particles obtained by subjecting an organometallic compound to calcination or light irradiation, and mixing the product with a planetary mill or a bead mill.

12) A method of producing an inorganic material paste according to any one of 1) to 10) above, wherein a solvent is added to an organometallic compound and inorganic material particles obtained by subjecting an organometallic compound to calcination or light irradiation, and the product is mixed with a planetary mill or a bead mill.

13) The method of producing an inorganic material paste according to 12) above, wherein used are inorganic material particles produced by performing a step of subjecting an organometallic compound to calcination at 200 to 500° C. or light irradiation, or a step of further subjecting the organometallic compound to calcination in a temperature range of 500 to 1500° C. or light irradiation, or by repeating these steps two or more times.

### Effect of the Invention

The inorganic material paste according to the present invention can reduce the amount of glass material, reduce the film thickness because the volume density of the functional material is high, yield favorable production efficiency, and achieve cost reduction since it is suitable for mass production. For instance, upon producing a thin film resistor, the resistor obtained by using the paste of the present invention is characterized in having superior stability even in the form of a thin film, and having minimal change in the resistance value caused by self-heating even under a high current. Moreover, the present invention yields a superior effect of being able to easily produce thick films of various oxide materials such as fluorescent substances, dielectrics and battery materials, without limitation to resistors.

### DETAILED DESCRIPTION OF THE MENTION

The inorganic material paste of the present invention is a material that is obtained by mixing an organometallic compound and inorganic material particles, and a solvent. As the organometallic compound, most preferably used is acetylacetonato or metal organic acid salt from the perspective of uniformity of the particle size and metal composition. The inorganic material particles are made from metal oxide, metal, or both. The combination of these materials is arbitrary, and these materials may be suitably combined (mixed) and used.

As the inorganic material particles to be used in the inorganic material paste, used may be a material having a composition where A (at least one metal among Sb, Ta, Nb, Ga, Cu, Ba, and Sr) is contained in SnO₂ or RuO₂, and A/[A+(Sn or Ru)] is 2 to 25%.

Moreover, as the inorganic material particles to be used in the inorganic material paste, used may be a material having a composition where A (at least one metal among Sb, Ta, Nb, Ga, Cu, Ba, and Sr) is contained in RuO₂ and SnO₂, and A/(A+Sn+Ru) is 2 to 25%.

The component ratio (weight ratio) of the foregoing inorganic material particles and organometallic compound is desirably 90/10 to 80/20.

Moreover, as the inorganic material particles to be used in the inorganic material paste, it is effective to use a material that is (1+a)A₁₋ₓBₓMn_{1-y}Cu_{y}O₃ (−0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0).

Upon producing the inorganic material paste, the inorganic material paste is preferably produced by adding a solvent to an organometallic compound and metal oxide inorganic material particles, and mixing the obtained product with a planetary mill or a bead mill.

Moreover, upon producing the inorganic material paste, the inorganic material paste is preferably produced by using inorganic material particles produced by performing a step of subjecting an organometallic compound to calcination at 200 to 500° C. or light irradiation, or a step of further subjecting the organometallic compound to calcination in a temperature range of 500 to 1500° C. or light irradiation, or by repeating these steps two or more times.

As a specific example of the foregoing production process, an inorganic material paste can be produced according to a method of adding, to a powder prepared by performing calcination at 200 to 500° C. to a solution having, as its main component, an organometallic compound in which at least one or more elements among antimony, niobium, tantalum, copper, vanadium, iron, barium, strontium, calcium, and bismuth are included in tin as the inorganic material particles with a controlled particle size, an organometallic compound in which at least one or more elements among antimony, niobium, tantalum, copper, vanadium, iron, barium, and strontium are included in tin, and a solvent, and mixing the obtained product in a planetary ball mill.

In the conductive mechanism of the resistor formed with the inorganic material paste devised by the present inventors and others, since the amount of insulating material made from glass or the like is considerably reduced, or the glass component is no longer required depending on the purpose, it is possible to maintain a stable conductive mechanism. Moreover, since self-heating is limited even in a high current, it is possible to yield a stable resistance value performance even under a high temperature environment.

In light of the relation between sensitivity and stability of the inorganic material performance, the present invention can produce a high density sintered compact with a high volume density from a material having conductivity because, through calcination, the organometallic compound will become the intended metal oxide by reducing, or not using, a glass composition, and using conductive particles as a binder made from an organometallic compound having the same metal composition as, or a different composition from, the conductive particles.

A preferred embodiment of the present invention is now explained, and in this embodiment, for application in a resistor as an example of producing an oxide thick film, a paste was produced by using a material obtained by doping tin oxide with antimony, an organometallic compound containing tin and antimony, and a solvent, and mixing the solution with a planetary ball mill. Consequently, a conductor film was produced and its electrical conductivity and temperature coefficient of resistance were evaluated. In this process, the following types of conductive oxide and organometallic compound were used.

### (Organometallic Compound Raw Material)

As the raw material for synthesizing particles, any organometallic compound may be used, but preferably used is inexpensive metal organic acid salt, and an organometallic compound with a high carbon number is preferable for inhibiting aggregation and crystal growth. Specifically, used may be metal organic acid salt in which its organic acid is selected from a group consisting of naphthenic acid, 2-ethylhexanoic acid, caprylic acid, stearic acid, lauric acid, butyric acid, propionic acid, oxalic acid, citric acid, lactic acid, benzoic acid, salicylic acid, and ethylenediaminetetraacetic acid.

Furthermore, an organometallic compound containing chelate such as metal acetylacetonato may also be used. In addition, as a method of preventing crystal growth, it is also effective to add a material such as organic nano particles or a carbon material that becomes subjected to carbonization and sublimation at calcination of 500° C. or higher, and perform calcination thereto.

### (Synthesis of Inorganic Material Particles)

As the inorganic material particle synthesizing method, used may be a step of subjecting the organometallic compound raw material to calcination at 200 to 500° C. or light irradiation, or a step of further subjecting the organometallic compound raw material to calcination in a temperature range of 500 to 1500° C. or light irradiation, or a step of subjecting the organometallic compound raw material to calcination by repeating the foregoing steps two or more times. And as the inorganic material particles, used may be the inorganic material particles that are produced via pyrolysis, laser reaction, microwave reaction, or plasma reaction by spraying, or performing the gas phase method to, a solution containing an organometallic compound raw material or metal, or inorganic material particles that are produced by pulverizing the inorganic material particles, which are obtained by mixing metal oxide, carbonate and the like and through a solid-phase reaction based on calcination, in a mortar, a planetary mill or a bead mill.

### (Particle Size Control)

Inorganic material particles which use an organometallic compound as its raw material and which are produced via pyrolysis, laser reaction, microwave reaction, or plasma reaction can be formed as fine particles, and, while the particle size ranges from 0.01 to 10 μm, it is effective to control the particle size distribution by more finely pulverizing the inorganic material particles based on a pulverization method using a mortar, a ball mill, a bead mill or the like.

Moreover, upon performing the foregoing pulverization, an organic solvent and an organometallic compound as a binder may be used. Specifically, alumina balls may be placed in an alumina container together with the inorganic material particles and the organometallic compound, and a planetary ball mill may be used for performing pulverization and producing ink for roughly 15 minutes to 4 hours at 500 to 2000 rpm to obtain a paste.

### (Binder)

As the organometallic compound to be used as a binder, used may be metal acetylacetonato or metal organic acid salt. Specifically, used may be an organometallic compound of an organic acid selected from a group consisting of naphthenic acid, 2-ethylhexanoic acid, caprylic acid, stearic acid, lauric acid, oleic acid, palmitic acid, butyric acid, propionic acid, oxalic acid, citric acid, lactic acid, benzoic acid, salicylic acid, and ethylenediaminetetraacetic acid. In particular, a solution with high viscosity is effective from the perspective of uniform dispersion.

In addition to the foregoing organometallic compounds, it is possible to use at least one or more types selected from toluene, xylene, ethanol butanol, acetylacetone, and butanol as the organic solvent, and additionally use ethylene glycol, propylene glycol, diethylene glycol, or triethylene glycol.

In addition to the foregoing organometallic compounds, cellulose resin, acrylic resin or the like may also be used as the organic binder. Terpineol, butyl carbitol acetate or the like may be used as the organic solvent, and any publicly-known version may be used.

Moreover, while a standard resistor paste contains 30% to 50% of glass components, the present method can produce a thin film that adheres to a substrate by keeping the amount of glass components to be 30% or less, or preferably without adding any glass component. As a result of reducing the amount of glass components as described above, it is possible to improve the thermal conductivity and suppress self-heating. Moreover, it is effective to add a material with high thermal conductivity to control self-heating. Specifically, the addition of metal particles or metal oxide is effective.

### (Conductive Oxide)

As the oxide configuring the conductive particles in the inorganic material particles, used may be a material in which ruthenium oxide or tin oxide is doped with antimony. Specifically, the amount of antimony to be doped is preferably 2 to 25%, and most preferably 5 to 15%. Moreover, the independent or simultaneous inclusion of niobium, tantalum, copper, vanadium, iron, barium, and strontium is also effective for improving the stability.

Furthermore, an oxide in the form of a complex oxide of tin oxide and another oxide may also be used. As the complex oxide, used may be ruthenium oxide or perovskite-type oxide (lanthanum manganese oxide, lanthanum iron oxide, lanthanum copper oxide, bismuth copper oxide, lanthanum nickel oxide or the like). In addition, a material obtained by mixing multiple materials and compositions, which are obtained by mixing the foregoing materials, may also be used.

### (Other Inorganic Materials)

So as long as it is an inorganic material, a paste of a material other than conductive particles may also be used. Specifically, the paste of the present invention can also be applied to producing fluorescent substances, dielectrics, optical materials, battery materials, and the like. Other than oxide materials, materials made from nitride, sulfide material, metal or the like may also be used.

### (Ratio of Inorganic Material and Organometallic Compound)

With regard to the component ratio (weight ratio) of the respective components of the paste, the ratio of the metal oxide configuring the conductive particles and the organometallic compound containing such metal is preferably 90/10 to 80/20, and more preferably 60/40 to 80/20. Note that, with a paste containing tin oxide that is independently dispersed as described above, the total of the amount of the glass composition and the ruthenium oxide configuring the conductive particles, and the amount of ruthenium oxide that is independently dispersed, is preferably within the foregoing range.

### EXAMPLES

The present invention is now explained in detail with reference to the Examples and Comparative Examples. Note that these Examples are merely illustrative and the present invention shall in no way be limited thereby. In other words, various modifications and other embodiments are covered by the present invention, and the present invention is limited only by the scope of its claims.

### Example 1

Tin acetylacetonate and antimony acetate were dissolved in butanol, and weighted and uniformly mixed to achieve an antimony concentration Sb/(Sb+Sn) of 10%. This solution was placed in a crucible and the solvent was dried at 100° C. Pre-calcination was subsequently performed at 200 to 300° C., and calcination was thereafter performed at 400° C. to prepare an antimony-doped tin oxide powder.

The obtained powder was placed in a planetary mill alumina container, and subsequently tin acetylacetonato (by Nihon Kagaku Sangyo), an antimony EMOD solution (manufactured by Kojundo Chemical), butanol as the solvent, and ethylene glycol were placed in the planetary mill alumina container and mixed for 30 minutes at a rotating speed of 800 rpm.

The obtained solution was spin-coated on an alumina substrate at 2000 rpm, dried at 200° C., and subjected to calcination for 10 minutes at 300° C. and for 10 minutes at 500° C. As a result of subsequently performing calcination for 10 minutes at 900° C., the sheet resistance at room temperature showed electrical conductivity of 20 Ω/cm².

### Comparative Example 1

For comparison with the resistive paste according to this embodiment, as with Example 1, a paste was produced using conductive particles made from an antimony-doped tin oxide powder and using ethyl cellulose as the vehicle, and the obtained paste was coated on an alumina substrate and subjected to calcination, but the film had low conductivity and easily became separated.

### Comparative Example 2

For comparison with the resistive paste according to this embodiment, as with Example 1, a paste was produced using conductive particles made from an antimony-doped tin oxide powder and using ethyl cellulose and glass as the vehicle, and the obtained paste was coated on an alumina substrate and subjected to calcination, but the film had low conductivity, and the sheet resistance was 8000/cm².

### Example 2

Naphthenic acid lanthanum, naphthenic acid manganese, and naphthenic acid strontium were mixed at a predetermined ratio, and this solution was placed in a crucible and the solvent was dried at 100° C. Pre-calcination was subsequently performed at 200 to 300° C., and calcination was thereafter performed at 600° C. to prepare a powder.

The obtained powder was placed in a planetary mill alumina container, subsequently naphthenic acid lanthanum, naphthenic acid manganese, and naphthenic acid strontium were mixed at a predetermined ratio, and the obtained solution was placed in a planetary mill alumina container together with toluene as the solvent, and mixed for 30 minutes at a rotating speed of 800 rpm. The obtained solution was spin-coated on an alumina substrate at 2000 rpm, dried at 200° C., and subjected to calcination for 10 minutes at 300° C. to 500° C. As a result of subsequently performing calcination at 1200° C., the sheet resistance of the film on the alumina substrate was 115 Ω/cm².

### Example 3

Naphthenic acid lanthanum, naphthenic acid manganese, and naphthenic acid strontium were synthesized as follows to obtain the respective powders; specifically, La:SrMn=0.8:0.2:1.0 (solution A), and La:SrMn=0.40:0.60:1.0 (solution B).

These powders were placed in a planetary mill alumina container, and subsequently naphthenic acid lanthanum, naphthenic acid manganese, and naphthenic acid strontium were mixed at a predetermined ratio of La:Sr:Mn=0.40:0.60:1.0, and the obtained solution was placed in a planetary mill alumina container together with toluene as the solvent, and mixed for 30 minutes at a rotating speed of 800 rpm. The obtained solution was spin-coated on an alumina substrate at 2000 rpm, dried at 200° C., and subjected to calcination for 10 minutes at 300° C. to 500° C.

As a result of coating the solution on an alumina substrate and performing calcination at 1100° C., the sheet resistance showed electrical conductivity of 100 Ω/cm².

### Comparative Example 3

Naphthenic acid lanthanum, naphthenic acid manganese, and naphthenic acid strontium were mixed at a predetermined ratio of La:SrMn=0.40:0.60:1.0, and the obtained solution was uniformly mixed in a toluene solvent and coated on an alumina substrate.

The coated film was subjected to calcination at 500° C., and subsequently subjected to calcination at 800° C. to 1100° C. Consequently, an oxide film was not generated, and no electrical conductivity was yielded.

### Comparative Example 4

Naphthenic acid lanthanum, naphthenic acid manganese, and naphthenic acid strontium were mixed at a predetermined ratio, and this solution was placed in a crucible and the solvent was dried at 100° C. Pre-calcination was subsequently performed at 200 to 300° C., and calcination was thereafter performed at 600° C. to prepare a powder.

The obtained powder and ethyl cellulose were dispersed in ethanol and toluene and coated on an alumina substrate. As a result of subjecting the substrate to calcination, the coating did not adhere to the substrate, and also showed high resistance.

### Example 4

One gram of Bi₂Sr₂CaCu₂O₈ (Bi2212) powder, and Kojundo Chemical-manufactured bismuth, strontium, calcium, and copper EMOD (0.5 mol/l toluene solution) were mixed at a predetermined ratio (2:2:1:2), and 3 ml of the obtained solution, 3 ml of toluene and 0.5 ml of butanol were placed in a planetary mill alumina container, and mixed for 15 minutes at a rotating speed 500 rpm.

The obtained solution was spin-coated on an alumina substrate at 1000 rpm, dried at 200° C., and subjected to calcination for 5 minutes at 500° C. This coating process was repeated 10 times, the temperature was raised to 800° C. over 1 hour, and calcination was thereafter performed for 3 hours at 800° C. Subsequently, as a result of performing calcination for 10 minutes at 900° C., a Bi₂Sr₂CaCu₂O₈ film (Bi2212 film) was obtained, and the sheet resistance at room temperature showed electrical conductivity of 20 D/cm².

### Comparative Example 5

Kojundo Chemical-manufactured bismuth, strontium, calcium, and copper EMOD (0.5 mol/l toluene solution) were mixed at a predetermined ratio (2:2:1:2), and the obtained solution was spin-coated on an alumina substrate and subjected to calcination under the same conditions, but a Bi2212 film was not generated, and no conductivity was yielded.

### INDUSTRIAL APPLICABILITY

The inorganic material paste according to the present invention can reduce the amount of glass material, reduce the film thickness because the volume density of the functional material is high, yield favorable production efficiency, and achieve cost reduction since it is suitable for mass production. For instance, upon producing a thin film resistor, the resistor obtained by using the paste of the present invention is characterized in having superior stability even in the form of a thin film, and having minimal change in the resistance value caused by self-heating even under a high current. Consequently, this paste is useful in producing thick films of various oxide materials such as fluorescent substances, dielectrics and battery materials, without limitation to resistors.

1. An inorganic material paste obtained by mixing an organometallic compound, inorganic material particles, and a solvent, wherein the inorganic material particles are obtained by subjecting an organometallic compound to calcination or light irradiation.

2. An inorganic material paste obtained by mixing an organometallic compound, inorganic material particles, and a solvent, wherein the organometallic compound is acetylacetonato or metal organic acid salt.

3. The inorganic material paste according to claim 1, wherein the organometallic compound is acetylacetonato or metal organic acid salt.

4. An inorganic material paste obtained by mixing an organometallic compound, inorganic material particles and a solvent, wherein the inorganic material particles are made from a metal oxide, metal material, or both.

5. The inorganic material paste according to claim 4, wherein the inorganic material particles have a composition where A (which is at least one metal among Sb, Ta, Nb, Ga, Cu, Ba, and Sr) is contained in SnO₂ or RuO₂, and A/[A+(Sn or Ru)] is 2 to 25%.

6. The inorganic material paste according to claim 4, wherein the inorganic material particles have a composition where A (which is at least one metal among Sb, Ta, Nb, Ga, Cu, Ba, and Sr) is contained in RuO₂ and SnO₂, and A/(A+Sn+Ru) is 2 to 25%.

7. The inorganic material paste according to claim 4, wherein a component ratio (weight ratio) of inorganic material particles and the organometallic compound is 90/10 to 80/20.

8. The inorganic material paste according to claim 4, wherein the inorganic material particles are (1+a)A₁₋ₓBₓMn_{1-y}Cu_{y}O₃ where −0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0.

9. The inorganic material paste according to claim 4, wherein the inorganic material particles are Bi₂Sr₂(CaₓA₁₋ₓ)Cu₂O₈, where component A is one or more types of metals selected from Y, La, Pr, Sm, Nd, Ho, Yb, Lu, Eu, Ce, Tm, and Er, and 0≦x≦1.0.

10. The inorganic material paste according to claim 4, wherein the inorganic material particles are (1+a)A₁₋ₓBₓNiO₃ where −0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0.

11. A method of producing an inorganic material paste which is produced by adding a solvent to an organometallic compound and inorganic material particles obtained by subjecting an organometallic compound to calcination or light irradiation, and mixing the product with a planetary mill or a bead mill.

12. A method of producing an inorganic material paste according to claim 4, wherein a solvent is added to an organometallic compound and inorganic material particles obtained by subjecting an organometallic compound to calcination or light irradiation, and the product is mixed with a planetary mill or a bead mill.

13. The method of producing an inorganic material paste according to claim 12, wherein used are inorganic material particles produced by performing a step of subjecting an organometallic compound to calcination at 200 to 500° C. or light irradiation, or a step of further subjecting the organometallic compound to calcination in a temperature range of 500 to 1500° C. or light irradiation, or by repeating these steps two or more times.

14. The inorganic material paste according to claim 1, wherein the inorganic material particles are made from a metal oxide, metal material, or both.

15. The inorganic material paste according to claim 1, wherein the inorganic material particles have a composition where A, which is at least one metal among Sb, Ta, Nb, Ga, Cu, Ba, and Sr, is contained in SnO₂ or RuO₂, and A/[A+(Sn or Ru)] is 2 to 25%.

16. The inorganic material paste according to claim 1, wherein the inorganic material particles have a composition where A, which is at least one metal among Sb, Ta, Nb, Ga, Cu, Ba, and Sr, is contained in RuO₂ and SnO₂, and A/(A+Sn+Ru) is 2 to 25%.

17. The inorganic material paste according to claim 1, wherein a component ratio (weight ratio) of inorganic material particles and the organometallic compound is 90/10 to 80/20.

18. The inorganic material paste according to claim 1, wherein the inorganic material particles are (1+a)A₁₋ₓBₓMn_{1-y}Cu_{y}O₃ where −0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0.

19. The inorganic material paste according to claim 1, wherein the inorganic material particles are Bi₂Sr₂(CaₓA₁₋ₓ)Cu₂O₈, where component A is one or more types of metals selected from Y, La, Pr, Sm, Nd, Ho, Yb, Lu, Eu, Ce, Tm, and Er, and 0≦x≦1.0.

20. The inorganic material paste according to claim 1, wherein the inorganic material particles are (1+a)A₁₋ₓBₓNiO₃ where −0.2≦a≦0.2, component A is one or more types of metals selected from La, Pr, Sm, Nd, Ho, Yb, Lu, Eu, Ce, Tm, and Er, component B is one or more types of metals selected from Ba, Ca, and Sr, and 0≦x≦1.0, 0≦y≦1.0.
